(19) United States
(12) Patent Application Publication
(10) Pub. No.: US 2010/0200255 A1
(43) Pub. Date: Aug. 12, 2010

(54) GARDENING TOOL WTIH PRONGS AND BLADE MEMBER

(75) Inventor: Clive Robert Gee, Western Australia (AU)

Correspondence Address: NIXON & VANDERHYE, PC, 901 NORTH GLEBE ROAD, 11TH FLOOR, ARLINGTON, VA, 22203, US

(73) Assignee: SPECIALIST INNOVATIONS PTY LTD, Belmont, Western Australia (AU)

(21) Appl. No.: 12/376,717

(22) PCT Filed: Aug. 7, 2006
(86) PCT No.: PCT/AU06/01119

§ 371 Date: Feb. 6, 2009

(51) Int. Cl. A01B 1/16; A01B 1/06; A01B 1/10; A01B 1/22

(52) U.S. Cl. 172/375; 172/378

(57) ABSTRACT

A gardening tool including an elongate handle and a head portion. The head portion includes a receiving means for receiving an end of the handle. A curved blade member extends outwardly from the receiving means. A pronged portion also extends outwardly from the receiving means and generally oppositely to the blade member. The pronged portion has three prongs spaced apart and generally in parallel. Each prong has a bifurcated pointed tip for assisting in engaging soil and vegetation.

### FIELD OF THE INVENTION

The present invention relates to a gardening tool, such as a hand-held or hand-operated gardening tool for assisting in establishing, cultivating and maintaining gardens and garden beds. The gardening tool is intended particularly but not exclusively for removing weeds and unwanted lawn grass runners from garden beds.

### BACKGROUND TO THE INVENTION

Hand-held and hand-operated tools for performing basic gardening tasks such as weeding or cultivation of gardens and garden beds are known. However, it is often the case that a number of different implements need to be used for the overall maintenance and cultivation of such gardens. In addition, those implements that are available are often not effective in easily removing weeds, grass runners and other unwanted vegetation from garden beds. Further, it has been recognised that some known gardening implements can lead to strains or general discomfort in the person using the implement. This can be due, for example, to the necessity of having to bend down or kneel onto the garden or adjacent the garden in order to use the implement and complete the task at hand.

The present invention attempts to overcome at least in part the aforementioned disadvantages of previous hand-held garden tools and implements used in garden and garden bed cultivation and maintenance.

References to prior art in this specification are provided for illustrative purposes only and are not to be taken as an admission that such prior art is part of the common general knowledge in Australia or elsewhere.

### SUMMARY OF THE INVENTION

In accordance with one aspect of the present invention there is provided a gardening tool, comprising an elongate handle and a head portion, the head portion comprising:
a receiving means for receiving an end of the elongate handle;
a blade member extending outwardly from the receiving means, wherein a width of the blade member decreases and the blade member curves as the blade member extends outwardly; and
a pronged portion extending outwardly from the receiving means and generally oppositely to the blade member, wherein the pronged portion has at least two prongs spaced apart and generally in parallel, and each prong has a bifurcated pointed tip for assisting in engaging soil and vegetation.

The blade member preferably has a generally hooked shape and terminates in a pointed tip to assist in penetration of soil by the blade member. The blade member preferably extends outwardly and curves through an angle of about 30° to 70° to the handle. More preferably, the blade member curves through an angle of about 60° to the handle.

The blade member preferably has a curved cutting edge but may have a serrated edge for ripping soil and vegetation.

The prong members preferably extend outwardly through an angle of about 30° to 70° to a longitudinal axis of the handle. More preferably, the prong members extend outwardly through an angle of about 60° to the longitudinal axis of the handle.

The bifurcated pointed tip preferably defines a fork having at least two tines. The tines of each fork preferably diverge from each other as the prongs extend outwardly. The bifurcated pointed tip preferably forms between about one quarter and one third of the length of the prong.

Preferably the tool has two to five prongs. In a most preferred form, the tool has three prongs.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of preferred embodiments of the gardening tool of the invention, as well as the best method of performing the invention known to the inventor, given by way of example only, with reference to the accompanying drawings, in which:

FIG. 1 is a side view of a portion of a gardening tool in accordance with a first embodiment of the present invention;

FIG. 2 is a bottom plan view of the tool of FIG. 1;

FIG. 3 is a perspective view of a portion of a gardening tool in accordance with a second embodiment of the invention; and

FIG. 4 is perspective view of the gardening tool of FIG. 3 in use.

### DETAILED DESCRIPTION OF PREFERRED EMBODIMENTS

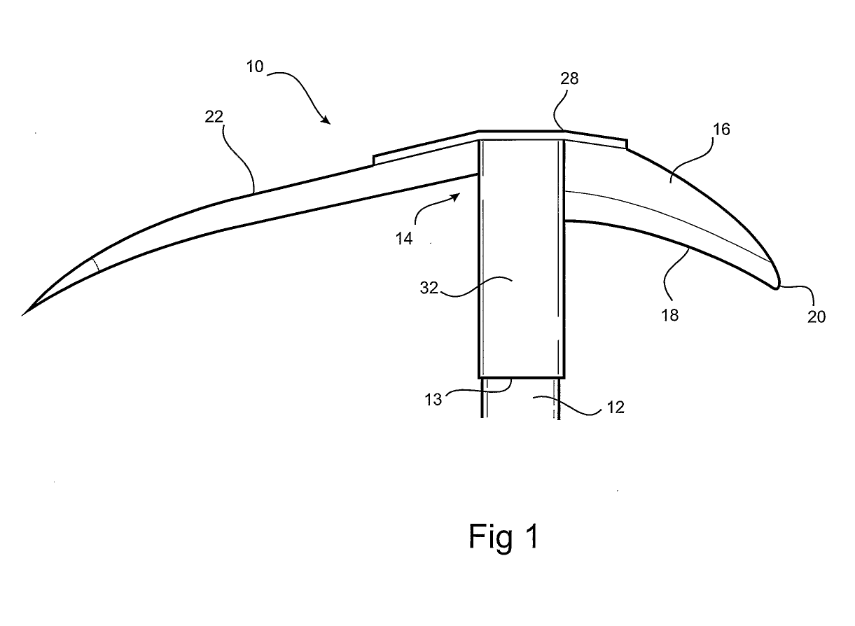

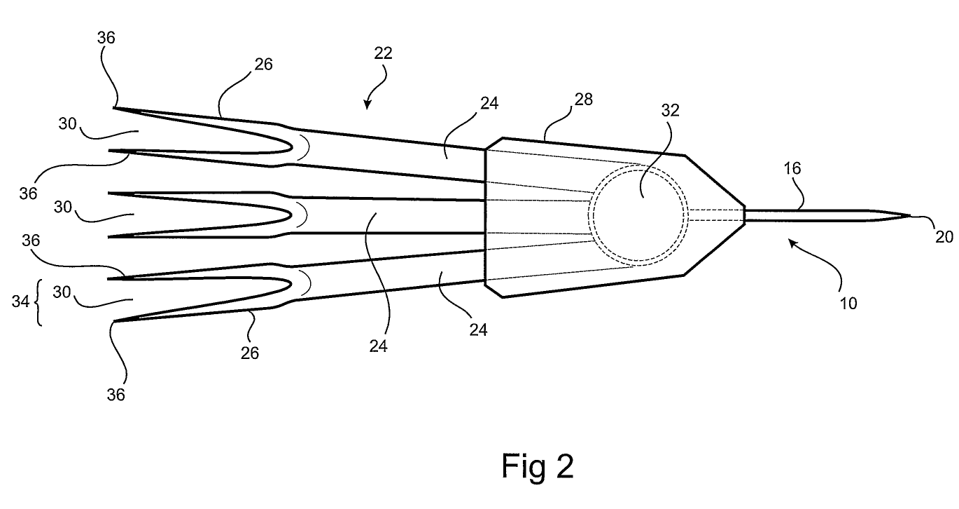

Referring to FIGS. 1 and 2, there is shown a gardening tool 10 for use in garden and garden bed cultivation and maintenance activities, such as weeding. The tool 10 includes an elongate handle 12 attached to a head portion 14. In the embodiment shown, the handle 12 is arranged generally perpendicularly to the head portion 14. The elongate handle 12 comprises a long shaft, having a length that permits a user of the tool 10 to remain substantially upright whilst engaging the head portion 14 of the tool 10 with earth or ground in use. The shaft is rigid and may be comprised of any sturdy and resilient material, such as wood, metal, or polymeric plastic such as polyethylene or poly propylene. Preferably, the shaft is made of a material that is able to withstand a substantial amount of outdoors exposure.

The elongate handle 12 is attached at one end 13 to the head portion 14 by a receiving means. In the embodiment shown in FIGS. 1 and 2, the receiving means comprises a generally tubular collar 32 having a diameter that is of a size adapted to snugly receive the end 13 of the handle 12. The handle 12 may be simply fitted within the collar 32 or may be further secured with a retaining means (not shown) such as a pin, bolt or other fastener, which passes through the collar 32 and the handle 12. Alternatively, the handle 12 may be connected to the collar 32 by means of a screw threaded connection (not shown).

The head portion 14 further includes a blade member 16, extending laterally outwardly from the collar 32. Preferably, the blade member 16 has a width that decreases as it extends outwardly. The blade member 16 is also preferably curved, terminating in a pointed tip 20. Preferably, the blade member 16 is curved through an angle of between about 30° and 70° to the handle 12, and preferably at an angle of about 60° to the handle 12 as can be seen in FIG. 1. The angle of 60° to the handle is believed to offer the best effect of the blade member 16 in use. The blade member 16 thus has a generally hooked or arcuate shape, having a curved cutting edge 18, as can be seen in FIG. 1. This hooked shape with the pointed tip 20 permits ready penetration of the blade member 16 into ground or soil.

The curved cutting edge 18 may be a sharp blade edge, as shown in FIG. 1, which is able to slice through ground and vegetation and act as an effective shredder and scarifier. Alternatively, the curved cutting edge 18 may be serrated (not shown), so as to provide more of a ripping, rather than slicing action.

The head portion 14 further includes a pronged portion 22 extending outwardly from adjacent the end 13 of the handle 12 and in a direction generally opposite to that of the blade member 16. The pronged portion 22 includes three prongs 24, spaced apart and substantially parallel to each other. In the embodiment shown in FIG. 2, the prongs 24 extend outwardly from the collar 32 and diverge as they extend outwards. The pronged portion 22 may have two or more prongs 24 but three prongs 24 gives the best effect in use of this part of the tool 10. It is preferred that the tool 10 has no more than a total of five prongs.

Each prong 24 extends and pitches outwardly through an angle of between about 30° and 70° to the handle 12, and preferably at an angle of about 60° as shown in FIG. 1. Each prong 24 may be slightly curved as it extends outwardly, as shown in FIG. 1.

Each prong 24 has a bifurcated pointed tip 26, defining a fork 34 with at least two tines 36 with a space 30 therebetween. As shown in FIG. 2, the tines 36 of each fork 34 diverge from each other as they extend outwardly.

The forks 34 are thus arranged to engage with a root or stem of a weed or other such vegetation in use, so as to enable the weed to be pulled upwardly and out of the soil. In this way, the tool is effective in clawing and grabbing the roots of weeds and invasive unwanted grass runners, such as Cooch and buffalo grasses, from garden beds.

In the first embodiment as shown in FIG. 2, the bifurcated pointed tip 26 is formed about two-thirds of the way down the length of the prong 24 so that the tip 26 defines about one third of the length prong.

Optionally, the head portion 14 is further provided with a plate member 28, arranged adjacent an outermost surface of the head portion 14. The plate member 28 may be provided so as to bind the collar 32, pronged portion 22 and blade member 16 of the head portion 14 together or simply to provide added reinforcement and strength to the head portion 14 as a whole.

In use, the handle 12 is grasped by an operator, typically adjacent an end furthest from the end 13 received by the collar 32 and also at a point intermediate along the shaft of the handle 12. The head portion 14 may be positioned such that the point 20 of the blade member 16 points generally towards the ground. The point 20 can then be caused to penetrate the ground by a downwards action, manipulated by the handle 12.

The blade 18 is then caused to slice or rip through ground and any vegetation by a generally back and forth motion, similar to the action used when manipulating a known ordinary garden hoe.

If it is desired to break up soil or engage and rip weeds or other vegetation from the soil, the head portion 14 is positioned such that the pronged portion 22 points generally towards the ground. The forks 34 of each prong 24 enter the ground and the tines 36 assist in the engagement of roots or stems of weeds or other such vegetation.

Upon pulling the head portion 14 generally upwards by manipulation of the handle 12, the vegetation so engaged between the forks 34 can be pulled outwardly of the soil.

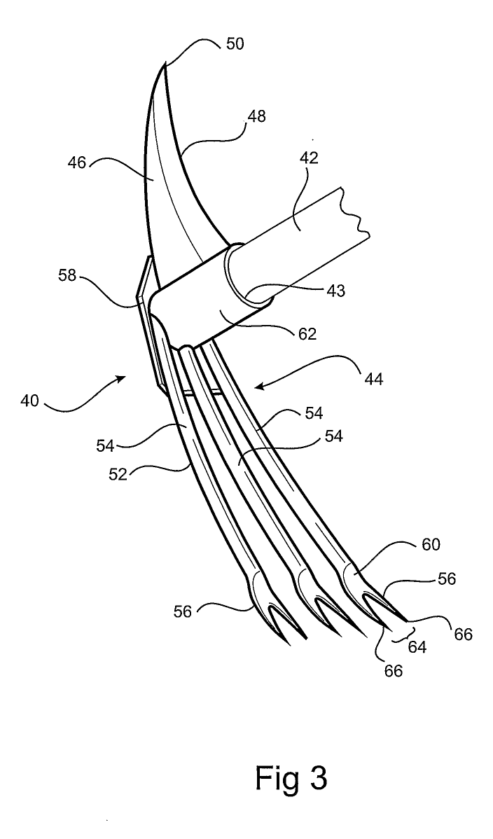

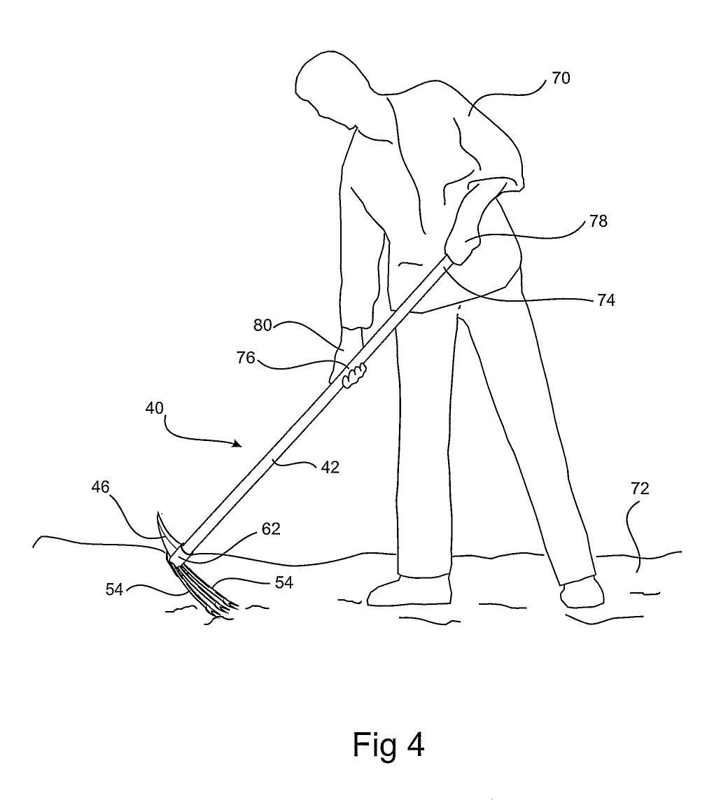

The embodiment shown in FIGS. 3 and 4 resembles the first embodiment in many respects and the second embodiment will therefore only be described in brief detail. The gardening tool 40 of the second embodiment includes an elongate handle 42 attached to a head portion 44. The handle 42 is arranged generally perpendicularly to the head portion 44.

The elongate handle 42 comprises a long shaft, having a length that permits a user of the tool 40 to remain substantially upright whilst engaging the head portion 44 of the tool 40 with ground 72 in use as can best be seen in FIG. 4.

The elongate handle 42 is attached at one end 43 to the head portion 44 by a receiving means. The receiving means comprises a generally tubular collar 62 having a diameter that is of a size adapted to snugly receive the end 43 of the handle 42. The handle 42 may be simply fitted within the collar 62 or may be further secured with a retaining means (not shown) such as a pin, bolt or other fastener, which passes through the collar 62 and the handle 42.

The head portion 44 further includes a blade member 46, extending laterally outwardly from the collar 62, terminating in a pointed tip 50. The blade member 46 is curved through an angle of about 60° to the handle 42. The blade member 46 has a generally hooked or arcuate shape, with a curved cutting edge 48. The curved cutting edge 48 may be a sharp blade edge or may be serrated (not shown).

The head portion 44 further includes a pronged portion 52 with three prongs 54, spaced apart and substantially parallel to each other. Each prong 54 extends and pitches outwardly through an angle of about 60° . Each prong 54 may be slightly curved as it extends outwardly, as shown in FIG. 3.

Each prong 54 has a bifurcated pointed tip 56, defining a fork 64 with at least two tines 66. The portion 60 of the prong 54 leading to the tines 66 is curved as can be seen in FIG. 3 which allows ease of contact with the soil and vegetation. In the second embodiment as shown in FIG. 3, the bifurcated pointed tip 56 is formed about three-quarters of the way down the length of the prong 54 so that the tip forms about one quarter of the length of the prong.

The head portion 14 has a plate member 28, arranged adjacent an outermost surface of the head portion 44. The plate member 58 binds the collar 62, pronged portion 52 and blade member 46 of the head portion 44 together and adds reinforcement and strength to the head portion 44 as a whole.

As can be seen in FIG. 4, in use the handle 42 is grasped by an operator 70 using a first hand 78, adjacent an end 74 furthest from the end 43 and with a second hand 80 at a point 76 intermediate along the shaft of the handle 42. Use of the tool 40 in this way allows the operator 70 to remain in a comfortable posture and without having to bend the back or knees. The tool could of course also be used by an operator in a sitting position, for example if the operator is disabled and unable to stand. The head portion 44 may be positioned such that the point 50 of the blade member 46 points generally towards the ground. The point 50 can then be caused to penetrate the ground by a downwards action, manipulated by the handle 42.

Modifications and variations as would be apparent to a skilled addressee are deemed to be within the scope of the present invention.

Now that several embodiments of the invention have been described in detail it will be apparent that the gardening tool in accordance with the invention provides a number of advantages over the prior art, including the following:
(i) It provides for a single tool which is versatile and can be used in a number of different ways for various gardening activities.
(ii) It has particular application for removing weeds and lawn runners from garden beds due to the bifurcated prongs which readily remove the roots of these unwanted plants, which is often difficult to achieve with other garden tools.
(ii) It allows gardening work to be undertaken in a comfortable posture thereby minimising the risk of injury to the user.
(iii) The design of the tool allows it to be easily used by the elderly and disabled since the device may be used from a comfortable standing or sitting position.
(iv) The tool can be manufactured to suit different soil and garden conditions for example by varying the number of prongs.

It will be readily apparent to persons skilled in the relevant arts that various modifications and improvements may be made to the foregoing embodiments, in addition to those already described, without departing from the basic inventive concepts of the present invention. The described examples are given for illustrative purposes only and therefore it will be appreciated that the scope of the invention is not limited to the specific embodiments described.

1. A gardening tool, including an elongate handle and a head portion, the head portion comprising:
a receiver receiving an end of the elongate handle;
a blade member extending outwardly from the receiving means, wherein a width of the blade member decreases and the blade member curves as the blade member extends outwardly; and
a pronged portion extending outwardly from the receiver and generally oppositely to the blade member, wherein the pronged portion has at least two prongs spaced apart and generally in parallel, and each prong has a bifurcated pointed tip.

2. A gardening tool according to claim 1, wherein the blade member has a hooked shape and terminates in a pointed tip.

3. A gardening tool according to claim 1, wherein the blade member extends outwardly and curves through an angle in a range of 30° to 70° to the handle.

4. A gardening tool according to claim 3, wherein the blade member curves through an angle of substantially 60° to the handle.

5. A gardening tool according to claim 1, wherein the blade member has a curved cutting edge.

6. A gardening tool according to claim 1, wherein the blade member has a serrated edge.

7. A gardening tool according to claim 1, wherein the prong members extend outwardly through an angle in a range of 30° to 70° to a longitudinal axis of the handle.

8. A gardening tool according to claim 7, wherein the prong members extend outwardly through an angle of substantially 60° to the longitudinal axis of the handle.

9. A gardening tool according to claim 1, wherein the bifurcated pointed tip defines a fork having at least two tines.

10. A gardening tool according to claim 9, wherein the tines of each fork diverge from each other as the prongs extend outwardly.

11. A gardening tool according to claim 1, wherein the tool has two to five prongs.

12. A gardening tool according to claim 11, wherein the tool has three prongs.

13. A gardening tool according to claim 1, wherein the bifurcated pointed tip forms between about one quarter and one third of the length of each prong.

14. (canceled)

15. A head of a gardening tool comprising:
a mount to receive an end of a handle of the gardening tool.
a blade extending outwardly from the mount in a first direction substantially perpendicular to the handle, wherein a width of the blade decreases and the blade curves as the blade extends outwardly from the mount; and
an assembly of prongs extending outwardly from the mount in a second direction substantially opposite to the first direction, wherein the assembly of prongs includes a plurality of prongs each having a bifurcated pointed tip.

16. The head of claim 15 wherein the width of the blade is parallel to the handle of the gardening tool.

17. The head of claim 15 wherein the wherein the blade curves through angles in a range of 30° to 70° to the handle.

18. The head of claim 15 wherein the prongs in the assembly of prongs include a shaft extending outwardly from the mount to the bifurcated pointed tip.

19. The head of claim 15 wherein the blade member extends outwardly and curves through angles in a range of 30° to 70° to the handle.

20. A head of a gardening tool comprising:
a mount including a cylindrical collar to receive an end of a handle of the gardening tool.
a blade affixed to the collar and extending outwardly from the mount in a first direction perpendicular to the handle, wherein the blade curves through angles in a range of 30 degrees to 70 degrees to the handle as the blade extends outwardly from the mount, the blade is parallel to the handle and a width of the blade narrows as the blade extends outwardly from the mount; and
prongs extending outwardly from the mount in a second direction opposite to the first direction, wherein each of the prongs includes a shaft affixed at one end to the collar and having an opposite end forming a bifurcated pointed .
